(19) United States
(12) Patent Application Publication
(10) Pub. No.: US 2007/0289270 A1
(43) Pub. Date: Dec. 20, 2007

(54) Filter for purifying gas mixtures and method for its manufacture

(76) Inventors: Bernd Schumann, Rutesheim (DE); Joerg Jockel, Gerlingen (DE); Matthias Kruse, Stuttgart (DE)

Correspondence Address: KENYON & KENYON LLP, ONE BROADWAY, NEW YORK, NY, 10004, US

(21) Appl. No.: 11/818,595

(22) Filed: Jun. 14, 2007

(30) Foreign Application Priority Data
Jun. 14, 2006 (DE) 102006027578.0

(51) Int. Cl. B01D 46/00

(52) U.S. Cl. 55/486; 55/523

(57) ABSTRACT

A filter for purifying gas mixtures containing particulates, in particular exhaust gases of internal combustion engines containing soot. The filter has a porous wall made of a filter base material through which the gas mixture to be purified flows. A surface coating of ceramic fibers is applied to the surface of the wall which is exposed to the flow of the gas mixture to be purified. The ceramic fibers are coated with nanoparticles. Furthermore, a method for manufacturing such a filter.

### FIELD OF THE INVENTION

The present invention relates to a filter for purifying gas mixtures containing particulates, in particular exhaust gases of internal combustion engines containing soot. The present invention furthermore relates to a method for manufacturing such a filter.

### BACKGROUND INFORMATION

A device for purifying gas mixtures containing particulates, the device being designed as a filter which has a porous surface made of filter base material exposed to the gas mixture to be purified is known, for example, from German Patent Application No. DE 10 2005 017 265. In this document, a layer of ceramic fibers is applied to the surface of the filter base material exposed to the gas mixture to be purified. The ceramic fibers are conglutinated with the filter base material using a binder. The binder is an inorganic material based on aluminum oxide, silicon oxide, or aluminum silicate, for example. Furthermore, German Patent Application No. DE 10 2005 017 265 describes that the ceramic fiber layer additionally contains spherical particles or other ceramic fibers having a relatively small aspect ratio of 1:5 to 1:1. These are used as spacers between the individual fibers and facilitate the setting of a desired porosity. The spherical particles may carry a catalytically active substance.

### SUMMARY OF THE INVENTION

A filter according to the present invention for purifying gas mixtures containing particulates has a porous surface made of filter base material through which the gas mixture to be purified flows. A layer of ceramic fibers is applied to the surface of the filter base material on the side exposed to the gas mixture flow. According to the present invention, the fibers are coated with nanoparticles. The advantage of coating the fibers with nanoparticles is that the mutual adhesion of the fibers is improved. In addition, the surface area is enlarged, which increases the capacity for accumulating soot.

Since soot preferably deposits at the points of intersection of the fibers, the nanoparticles will also deposit specifically at the points of intersection. Furthermore, the nanoparticles are preferably catalytically active. By using catalytically active nanoparticles, the catalytically supported burn-off behavior of the soot particles may be deliberately controlled. Suitable catalytically active substances which are applied to the nanoparticles are, for example, noble metals of the platinum group, preferably platinum or palladium. In the presence of these catalytically active materials, hydrocarbons adhering to the soot particles are oxidized and thus removed from the soot particles. This makes the soot particles disintegrate and thus become more easily oxidizable. Further suitable catalytically active substances are lanthanoids, preferably cerium, and elements of the fifth to eighth groups, preferably vanadium, iron, and molybdenum. These substances are contact catalysts which lower the soot burn-off temperature. The different catalytically active substances may be applied to the nanoparticles either individually or in mixtures.

The material from which the nanoparticles are manufactured is preferably selected from aluminum oxides, silicon oxides, aluminum silicates, titanium oxide, zirconium oxide, lanthanum oxide, and cerium oxide, or mixtures thereof. One advantage of these oxides is their high heat resistance, so that the nanoparticles are not destroyed even during the thermal regeneration of the filter.

The ceramic fibers which are applied to the surface of the filter base material and are exposed to the gas mixture flow preferably have a mean length in the range of 150 μm to 450 μm and/or a mean diameter in the range of 3 μm to 10 μm. In general, the nanoparticles have a mean diameter of 5 nm to 50 nm and preferably a mean diameter in the range of 25 nm. Due to the fact that the mean diameter of the nanoparticles is much smaller than the mean diameter of the ceramic fibers, the surface area is significantly enlarged in the positions where the nanoparticles deposit on the fibers. The capacity to accumulate particles is increased due to the increased surface area. The filter designed according to the present invention may accumulate more particles than a filter such as known from the related art.

In general, the ceramic fibers of the layer which is applied to the surface of the filter base material are conglutinated with each other and with the filter base material by a binder. The mutual adhesion of the fibers is increased due to the nanoparticles which preferably deposit at the points of intersection of the ceramic fibers.

The binder is preferably an inorganic material based on aluminum oxide, silicon oxide, or aluminum silicate. This makes a particularly good binding of the ceramic fibers to the porous filter surface possible. The ceramic fibers are made of an aluminum oxide, an aluminum silicate, optionally with zirconium dioxide added, of silicon dioxide, zirconium dioxide, or oxides or mixed oxides of transition metals such as cerium, lanthanum, molybdenum, or iron.

The filter base material is preferably made of a sintered metal or a ceramic material. This ensures sufficient gas permeability of the filter base material. At the same time, the filter base material is heat-resistant, so that the filter base material withstands the high temperatures occurring during the regeneration of the filter.

The present invention furthermore relates to a method for manufacturing a filter as described above, including the following steps:
a) applying a layer made of ceramic fibers to the surface of the filter base material,
b) applying a solution containing nanoparticles,
c) drying and calcining the filter.

The ceramic fibers may be introduced into the filter by suction through or into the filter. To do so, a suspension containing the ceramic fibers is applied to the surface of the filter base material. After evaporating the solvent, which may be accelerated by a suitable heat treatment, the excess portion of the suspension applied may be drawn off with the aid of a suitable suction device at partial vacuum through the pores of the filter base material. This step may be followed by additional drying and/or calcining.

The ceramic fibers are preferably coated by immersion into a solution containing the nanoparticles. Due to the capillary forces acting in the interstices between the ceramic fibers, the nanoparticles preferably deposit at the points of intersection of the ceramic fibers. The quantity of the nanoparticles depositing on the fibers may be set by setting the immersion parameters. The immersion parameters, which may be varied, are, for example, the concentration of the nanoparticles in the solution, the temperature, the viscosity, and the time.

After immersion into the solution containing the nanoparticles, the filter thus coated is dried again and subsequently calcined.

If the nanoparticles are catalytically active, the catalytically active substances are applied by an impregnation method essentially known to those skilled in the art. Such impregnation methods include, for example, immersion, soaking, or spraying with a solution containing the catalytically active substance.

### BRIEF DESCRIPTION OF THE DRAWINGS

FIG. 1 schematically shows a filter provided with surface coating.

FIG. 2 schematically shows the structure of a layer of ceramic fibers containing nanoparticles.

### DETAILED DESCRIPTION

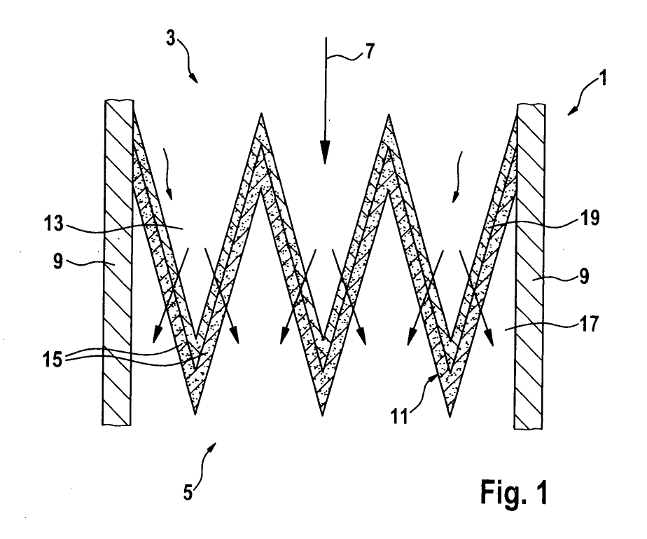

FIG. 1 shows the schematic structure of a filter for purifying gas mixtures. The filter is, for example, integrated into a system in which a gas mixture containing particulates which are preferably combustible is conducted. The system may be the exhaust gas duct of a Diesel combustion engine, for example. Alternatively, there is also the possibility to situate the filter in a bypass of the exhaust system.

A filter 1, as shown in FIG. 1, is designed as a stainless steel or sintered metal filter, for example, and has a first side 3 facing the gas mixture to be purified and a second side 5 facing the purified gas mixture. A gas mixture 7 loaded with particles is supplied to filter 1 on its first side 3. Gas mixture 7 loaded with particles is, for example, an exhaust gas stream of a diesel engine, containing soot.

Filter 1 has a housing 9 into which a filter structure 11 is integrated. Filter structure 11 includes pockets 13, whose ends facing first side 3 are open for receiving the gas mixture loaded with particles, and whose ends facing second side 5 are sealed. Pockets 13 are preferably delimited, on their longitudinal sides, by walls 15, which have a porous design, so that they ensure the passage of the gas mixture while retaining the particulates contained in the gas mixture.

The gas mixture passing through walls 15 reaches second pockets 17, whose ends facing first side 3 are sealed and whose ends facing second side 5 are open, in such a way that the gas mixture freed of particulates may escape. Housing 9 and walls 15 are made of a metallic material such as sintered metal or stainless steel, for example. It is furthermore possible that housing 9 and walls 15 are made of different materials.

To increase the filtering surface of walls 15, the walls are provided, at least partially but preferably over the entire surface, with a surface coating 19 made of ceramic fibers. The ceramic fibers are made, for example, of an aluminum oxide, an aluminum silicate, optionally with zirconium dioxide added, of silicon dioxide, zirconium dioxide, or oxides or mixed oxides of transition metals such as cerium, lanthanum, molybdenum, or iron. The fibers have a mean diameter of 3 μm to 10 μm, in particular 5 μm, and a mean length of 150 μm to 400 μm, preferably 250 μm.

The fibers are applied to the filter base material of walls 15, forming surface coating 19 in such a way that the pore structure of porous walls 15 is not conglutinated and the fiber composite obtained is homogeneously distributed on walls 15. Furthermore, the individual fibers of surface coating 19 are conglutinated in such a way that no fibers may get loose from the fiber composite even at high flow velocities of gas mixture 7 to be purified. Aluminum oxides, aluminum silicates, or silicon oxides, initially present as liquid sols or colloidal solutions, are well suited as conglutinants.

These largely soluble or dispersed compounds form gels via a condensation step, with separation of water. One advantage of this sol-gel process is that ceramic coatings may be produced in a simple manner.

For this purpose, a solution of suitable hydrolyzable alcoholates of multivalent metal ions such as silicon or aluminum in water or a suitable alcohol is initially produced. The ceramic fibers are then suspended in the solution, and the solution is applied to the surface of walls 15 to be coated. Depending on the water content, a dispersing agent, for example, in the form of a surfactant, is added to reduce the surface tension. To homogenize the suspension, it is subsequently immersed into an ultrasound bath preferably for a few minutes. While the solvent is evaporated at low temperatures, a metal hydroxide network is formed. If the gel is subsequently subjected to a suitable heat treatment, further condensation or polymerization steps follow with the formation of a network structure over metal oxide groups.

The excess portion of the suspension applied is then drawn off through the pores of walls 15 with the aid of a suitable suction device at partial vacuum. This is followed by a heat treatment of walls 15 treated with the suspension, for example, at a temperature of 110° C. for approximately 60 minutes to initiate the sol-gel process.

Suitable suspensions for producing surface coating 19 are, for example, suspensions on the basis of a silicon oxide sol or on the basis of an aluminum oxide sol and contain 0.1% to 10% by weight of aluminum oxide fibers, in particular 0.2% to 0.9% by weight.

After applying the ceramic fibers of surface coating 19 onto walls 15 on the side exposed to gas mixture flow 7, coating using nanoparticles follows. The coating may be performed, for example, after pre-drying surface coating 19 having the ceramic fibers or after calcination of the filter.

The mutual adhesion of the ceramic fibers is enhanced by the coating with nanoparticles. In addition, the surface is enlarged by the nanoparticles deposited on the ceramic fibers. The capacity of filter 1 to accumulate particles is also increased due to the increased surface area.

The ceramic fibers are coated with nanoparticles by an immersion process, for example. For this purpose, after the application of surface coating 19 having the ceramic fibers, the filter is immersed into a solution containing the nanoparticles.

Due to the capillary forces acting in the pores between the ceramic fibers, the nanoparticles preferably deposit at the points of intersection of the fibers. The quantity of nanoparticles depositing on the ceramic fibers may be set by setting the concentration of nanoparticles in the solution, the temperature variation, or the variation of the viscosity. The concentration of nanoparticles in the solution is preferably in the range of 0.1% to 5% by weight. Immersion preferably takes place at a temperature in the range of 20° C. to 60° C. for a period of a few seconds to a few minutes, preferably 30 to 60 seconds, the viscosity of the solution being in the range of 0.8 mPa to 80 mPa, preferably in the range of 1 mPa to 20 mPa.

The nanoparticles are preferably made of aluminum oxide, silicon oxide, an aluminum silicate, titanium dioxide, zirconium dioxide, or a mixture of these oxides. The solvent in which the nanoparticles are suspended is preferably an aqueous and/or alcoholic solvent.

In general, the nanoparticles adhere to the fibers by drying. It is, however, also possible that the solution contains a binder, in addition to the nanoparticles, via which the nanoparticles are bonded to the fibers. As described above, aluminum oxides, aluminum silicates, or silicon oxides are suitable as binders.

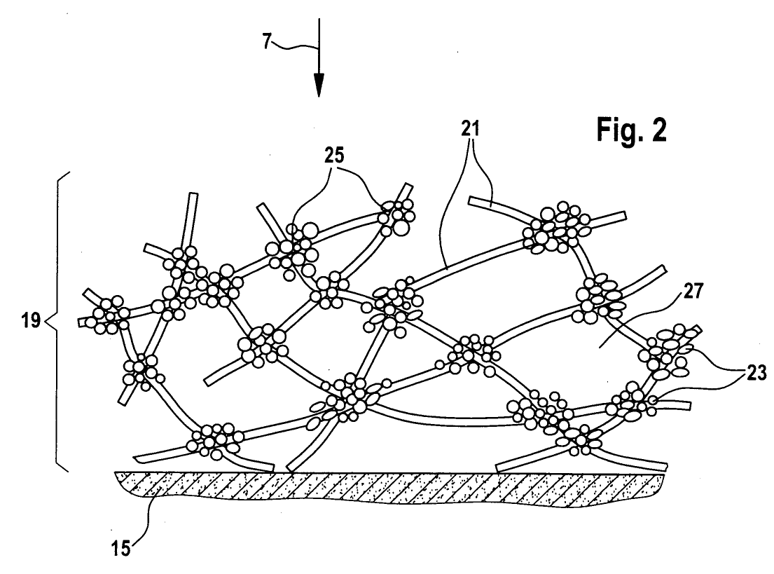

FIG. 2 schematically shows the structure of a filter coated with a layer of ceramic fibers and the nanoparticles deposited thereon.

As is evident from FIG. 2, surface coating 19 contains ceramic fibers 21, which are coated with nanoparticles 23. Ceramic fibers 21 are preferably coated with nanoparticles 23 at the points of intersection 25 of ceramic fibers 21. Since the particles contained in the gas stream are also preferably deposited at the points of intersection of ceramic fibers 21, an enlarged surface at points of intersection 25, as achieved, for example, by coating with nanoparticles 23, also increases the capacity of filter 1 to accumulate particles.

Due to the enlarged interstices 27 between ceramic fibers 21, compared to the pores in wall 15, the pressure drop decreases only slightly compared to a filter 1 without deposits, even when a large amount of particles is deposited. The particulates to be removed from gas mixture 7 deposit on the surface which is enlarged due to nanoparticles 23. However, this reduces interstices 27 only to a slight degree. As particles deposit on wall 15 made of the filter base material, i.e., in the pores of wall 15, they accumulate, and the pressure drop increases with increasing load in filter 1. However, since due to surface coating 19 made of ceramic fibers 21 having nanoparticles 23, the particles from gas mixture 7 which are to be removed from gas mixture 7 in filter 1 deposit at points of intersection 25 of ceramic fibers 21 coated by nanoparticles 23, only a much smaller quantity reaches wall 15 and deposits there in the pores of wall 15.

In order to facilitate the oxidation of the soot particles for cleaning filter 1 or to lower the soot burn-off temperature, nanoparticles 23 are preferably catalytically active. For this purpose, nanoparticles 23 contain a catalytically active substance. Suitable catalytically active substances are, for example, noble metals of the platinum group, preferably platinum or palladium, which are used for oxidizing hydrocarbons. Since hydrocarbons adhere to the soot particles, they are oxidized in the presence of catalysts and thereby removed. The soot particles disintegrate and thus become more easily oxidizable. To lower the soot burn-off temperature, nanoparticles 23 are preferably provided with a contact catalyst. Suitable catalytically active substances for forming the contact catalyst are lanthanoids, preferably cerium, and elements of the fifth to eighth group, preferably vanadium, iron, and molybdenum. The catalytically active substances may be applied to nanoparticles 23 either individually or in mixtures. It is thus preferable, for example, if nanoparticles 23 contain both a noble metal of the platinum group for hydrocarbon oxidation to make the soot particles more easily oxidizable, and at least one contact catalyst for reducing the soot burn-off temperature.

What is claimed is:

1. A filter for purifying a gas mixture which contains particulates, comprising:
a porous wall composed of a filter base material, through which the gas mixture to be purified flows; and
a surface coating composed of ceramic fibers being applied to a surface of the wall which is exposed to the flow of the gas mixture to be purified, the ceramic fibers being coated with nanoparticles.

2. The filter according to claim 1, wherein the gas mixture is an exhaust gas from an internal combustion engine containing soot.

3. The filter according to claim 1, wherein the nanoparticles are composed of one of an aluminum oxide, silicon oxide, aluminum silicate, titanium dioxide, zirconium dioxide, and mixtures thereof.

4. The filter according to claim 1, wherein the ceramic fibers are coated with nanoparticles at their points of intersection.

5. The filter according to claim 1, wherein the nanoparticles contain at least one catalytically active substance.

6. The filter according to claim 5, wherein the catalytically active substance includes at least one of a noble metal of the platinum group, a lanthanoid, and an element of the fifth to eighth group of the periodic system.

7. The filter according to claim 6, wherein the noble metal of the platinum group is platinum or palladium, the lanthanoid is cerium, and the element of the fifth to eighth group is vanadium, iron, or molybdenum.

8. The filter according to claim 5, wherein a binder is an inorganic material based on one of aluminum oxide, silicon oxide, and aluminum silicate.

9. A method for manufacturing a filter comprising:
applying a layer made of ceramic fibers to a surface of a wall composed of filter base material;
applying a solution containing nanoparticles; and
drying and calcining the filter.

10. The method according to claim 9, wherein, after applying the layer made of ceramic fibers, the filter is dried and calcined.

11. The method according to claim 9, further comprising applying the solution and the nanoparticles contained therein to the ceramic fibers by immersion.

12. The method according to claim 9, further comprising applying the ceramic fibers to the surface of the wall composed of filter base material via one of a suction process and an immersion process.

13. The method according to claim 9, further comprising applying at least one catalytically active substance to the nanoparticles by an impregnation method.
